(19) United States
(12) Patent Application Publication
(10) Pub. No.: US 2019/0193939 A1
(43) Pub. Date: Jun. 27, 2019

(54) Intelligent Storage Chain System

(71) Applicant: Weiping Meng, Flushing, NY (US)

(72) Inventor: Weiping Meng, Flushing, NY (US)

(21) Appl. No.: 16/313,131

(22) PCT Filed: Jun. 27, 2016
(86) PCT No.: PCT/CN2016/087220

§ 371 Date: Dec. 24, 2018

(51) Int. Cl. B65G 1/137

(52) U.S. Cl. CPC B65G 1/1376; B65G 2203/0283

(57) ABSTRACT

The invention discloses a storage system, comprising of storage rack, combined access mechanism, access management control system; combined access mechanism comprising of material access mechanism, convey belt; access management control system comprising of optimal access time. The present invention (1) deletes redundant labor or time among storages; (2) improve the efficiency by 5-20 times comparing to the current similar technology.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to warehousing management and operational, particularly to a method and its apparatus for high efficiency access management storage system.

Currently in the most common storage system there are a series of obvious shortcomings such as search, access, long cleaning time and error prone, not only can this not meet the current scale production, but also can even more not adapt to the growing demand for small batch or even personalized production, and fast forward demand. Information technology, automation, intelligent and Internet+ technology being coupled to various fields offer the way for the solution. Some people have proposed to use wireless tag systems, robots and other means to reduce labor and error and improve the efficiency of storage management, but there are a large number of operations that should not be.

### BRIEF SUMMARY OF THE INVENTION

The purpose of the present invention is to provide a method and device for efficient storage system that can meet the fast access and minimization of operation requirements by using automation technology, information technology, computer control technology, internet, mathematics and other intelligent technologies.

The invention provides a systematic solution for realizing the above purposes, which is described in detail as follows:

A management method of storage chain system includes steps: (1) create a database of storage position layout or s-rack, called as s-database, (2) get information about the incoming materials and their conveying mode, (3) decide the distribution of material storage area, and (4) access management; the storage chain system here has three layers of meaning: 1) a storage usually has an entry of and an exit (IOPs) of ware material, is devided into many standard unit positions for storing material, these standard unit positions are called as s-positions or s-grids, and represented and positioned with a column ordinal number for vertical s-grids in the storage rack and/or a row ordinal number for horizontal s-grids in the storage rack, for an example, a s-grid (2,5) represents for the s-grid at the 2^{nd} col., the 5^{th} row in a s-rack, consecutive column/row ordinals s-grids are called as a s-area, total columns M, total rows N, total s-grids equals to M*N, a s-grid being not occupied is a vacant s-grid, a s-grid being occupied is a filled s-grid, the IOP port are arranged at the smallest ordinal number end column or the other end, each s-grid has a distance to the IOP port different from one s-grid another, simplifiedly using s-col. number as the distance called as s-distance, for an example, with the IOP port at the smallest number end col., the s-gird (2,5)'s-distance is 2, or with the IOP port at the biggest number end col, the s-gird (2,5)'s-distance is M−2; 2) the way of transporting materials between storages determines sorting and operation time, such as conveyor belts delivering material with the sorting of first in first out (FIFO), nevertheless vehicle delivering material with the sorting of first in last out (FILO), when three material A, B, C are delivered in the sorting A,B,C, the same sorting A,B,C are received if using conveyor belt, nevertheless the reverse sorting C,B,A may be received if using FILO vehicle; 3) delivery tools connects several storages as a supply-demand storage chain system.

Said step (1) the s-database of storage position layout makes storage location corresponding to the basic data item of the database, the basic data item includes many information fields;

Said step (2) the information about incoming materials and their conveying mode includes material category, amount, frequency, sorting, convey sorting, these information are from demand side, based on specifying or predicting or period-statistical data;

Said step (3) decide the distribution of material storage area, based on material category (MCAT), quantity of goods in and out at unit time (QIOT), local storage sorting needs (LS), sorting when conveying (CS), principle of layout s-grid and their re-layout for minimizing access operations (MP), for an example, the bigger the QIOT/day of a MCAT material the closer it should be arranged to the IOP port, MCAT A material's QIOT/day is 3 thousands reels, MCAT B material's QIOT/day 2 thousands reels, MCAT C material's QIOT/day 1 thousands reels, the IOP port are designed at 0 col. end, thus, an optimized local sorting layout (LS) called as local access priority is: MCAT A material is arranged in 0 col. of the s-rack, MCAT B material is arranged in 1 col. of the s-rack, MCAT C material is arranged in 2 col. of the s-rack, another optimized sorting layout (LS) is called as demand-side access priority, that's, local s-area is layouted sorting on demand-side access priority, for the example as above, if the best sorting at demand-side is B, C, A, then the local storage is layouted sorting as B, C, A, rather than local best sorting A, B, C, MCAT A material is arranged in 0 col. of the s-rack, and the 3^{rd} principle is the best matching priority of the local storage and the demand side, it adjusts the best sorting agreement between the demand side and the local storage, that's. demand-side's sorting also is A, B C, and more principles for sorting optimization; demand-side makes sorting-priority requests to supply-side;

Said step (4) access management further includes: (4.0) synergy with the supply-side, request to supply-side for sorting priority, (4.1) get access instruction, (4.2) change access mode: access means store/fetch, (4.2.1) store-mode-operation, further includes (4.2.1.1) get information of incoming material, (4.2.1.2) assign s-grids for incoming material, in terms of material's MCAT, s-areas and the vacant s-grids, and send the assignment info to convey system, (4.2.1.3) confirm material arrival at the TOP port, (4.2.1.4) convey system deliver the material to their assigned s-grids: convey system receives the incoming material, convey them to their s-grids, put them into their s-grids, send the “Done”-info to the TOP port and s-database, (4.2.2) fetch-mode-operation: further includes step (4.2.2.1) determine access optimization based on instruction, including local priority, demand-side priority, demand-supply matching priority etc, 1) the local priority fetch: arrange all the material being ordered from small to large in terms of local s-distance, and to be taken out in that local “small-to-large” order, that's, convey system based on that local order take out ordered material from their s-grid and send out of the TOP port, 2) the demand-side priority fetch: arrange all the material being ordered in terms of demand-side s-distance referring to convey-mode, in order to get such optimal way that the material will be received just in demand-side sorting, 3) the demand-supply matching priority fetch: adjust the pervious 1) and 2) so as to obtain some tradeoff optimal way, (4.2.2.2) determine s-grids of incoming material, (4.2.2.3) convey system run to the s-grid of the material, take the material out and deliver them out of the TOP port, send the “Done” info to s-database; restart next fetch operation, (4.2.2.4) optional operations: print the s-grid of demand-side on the fetched material; step (4.2.2.1) may be based on statistical data in step (2) to re-layout s-area optimally;

A storage system apparatus includes a s-rack, a combined store/fetch mechanism, and an access management control system;

Said combined store/fetch mechanism includes Transporter 1 that moves horizontally and Transporter 2 that moves horizontally and vertically in the same time, Transporter 1 is and move along the bottom on one side of the s-rack, Transporter 2 is and move above Transporter 1 and along its same side of the s-rack, up-down and forward-backward, responsible for taking material out from their s-grid and putting them onto Transporter 1, and for taking material up from Transporter 1 and putting them into their s-grids, including two pipeline operation modes of store and fetch;

Said access management control system includes a s-grid database called as s-database, a module for acquisiting information of storing material, a module for deciding layout of storage i.e., s-areas, a module for store/fetch control, a module for coordinating supply-side, a module for network communication, a module for reading information of storing material, a module for operating combined store/fetch mechanism, etc, including two operation modes of store and fetch;

The advantages of the present invention are below: (1) the optimization of storages' sorting of related warehouses of supply-demand can realize the non redundant operation or time between warehouses, warehouses and production lines, or called as “seamless” links, (2) more than 5 to 20 times more efficient than existing storage systems, (3) reduce labor and error.

### BRIEF DESCRIPTION OF THE DRAWINGS

FIG. 1 is Schematic Diagram of the Structure of the Storage Apparatus;

FIG. 2 is Schematic Diagram of the Combined Access Mechanism of the A-A Section in FIG. 1,

FIG. 3 is Schematic Diagram of the Access Management Control System;

FIG. 4 is Schematic Diagram of a Method of Intelligent Storage Chain System;

FIG. 5 is Schematic Diagram of Access Management Process;

FIG. 6 is Schematic Diagram of Store and Fetch Operation of a Transporting Set;

### LIST OF REFERENCE NUMERAL UTILIZED IN THE DRAWING

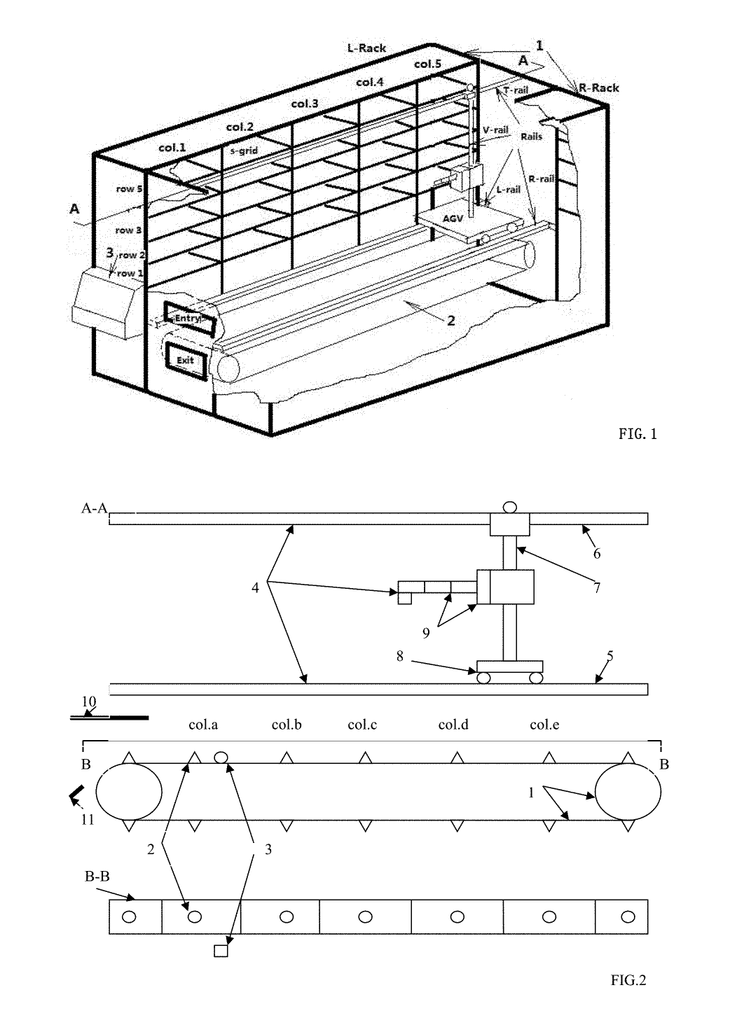

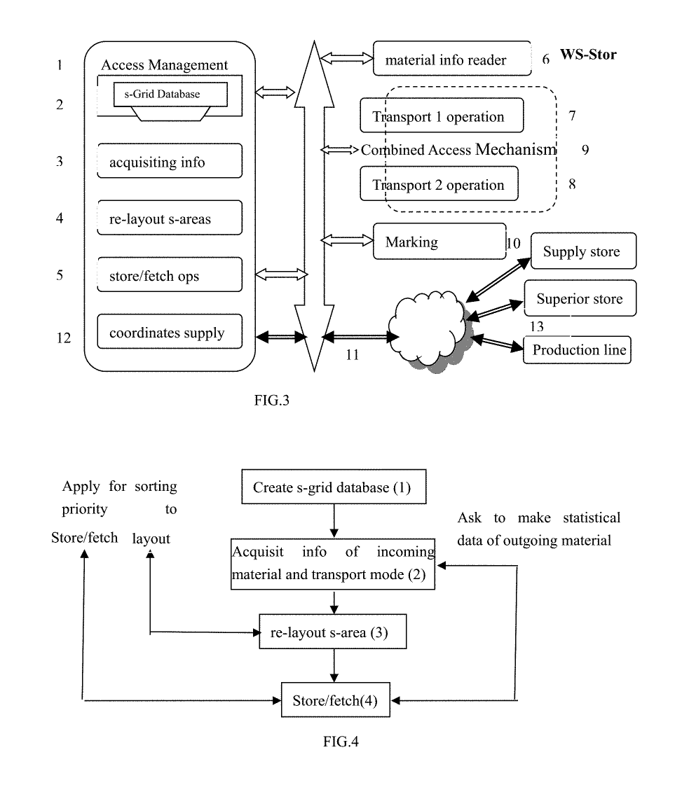

FIG. 1: 1—Material Shelves, L-Rack is one shelf at left side, R-Rack is the other shelf at right side, 2—Combined Access Mechanism, 3—Access Management Control System;
FIG. 2: 1—Transporter 1; 2—Material locator; 3—material feed sensor; 4—Transporter 2; 5—two guide-rails of horizontal movement, L-rail, R-rail; 6—top guide-rails of movement at top, T-rail,; 7—vertical guide-rails of vertical up-down movement, V-rail; 8—automatic vehicle of horizontal movement, AGV; 9—access Extraman; 10—material feed gate: 11—exit guide plate;
FIG. 3: 1—Access management computer system, 2—storage database, s-database, 3—module of acquisiting information of incoming material, 4—module of re-layout s-database, 5—module of store/fetch management, 6—incoming material information reader, 7—controller of transporter 1, 8—controller of transporter 2, 9—combined access mechanism, 10—marking machine, 11—communication networks, 12—module of synergy with supply-side, 13—other material storages in networks/internet: factory general warehouse, production line, demand-side warehouse, up-stream supply-side warehouse, book library and store, and their links etc;
   Note: the drive components such as stepper motors and other common configuration parts and mechanisms are not drawn.

### DETAILED DESCRIPTION OF THE INVENTION

### Description of the Preferred Embodiments, Industry Applications

A detailed description of an embodiment of the invention in conjunction with the accompanying drawings:

Create a storage apparatus system includes material shelves as shown in FIG. 1-1: double shelves, L-rack, R-rack, 5 columns, 5 rows, total 50 s-grid, col.1 is closest to entry/exit port (IOPs), combined store/fetch mechanism as shown in FIG. 1-2 running inside, FIG. 1-3 is access management computer system, material stored are 7 inch diameter chip disk, each s-grid can contain one and only one chip-disk, the storage's downstream is production-line, transport tool between the two storages is vehicle with FILO material sorting. The following illustrate the every part of the system;

In FIG. 2, combined access mechanism includes Transporter 1 as FIG. 2-1 and Transporter 2 as FIG. 2-4, Transporter 1 includes convey belt as FIG. 2-1, material limiting locator as FIG. 2-2, material feed sensor as FIG. 2-3, Transporter 2 is two dimension store/fetch Exraman, including left/right horizontal guide-rails as FIG. 2-5, top horizontal guide rail as FIG. 2-6, vertical guide rail as FIG. 2-7, automatic vehicle as FIG. 2-8, Extraman as FIG. 2-9, a material feed gate installed inside the entry as FIG. 2-10, a guide plate installed inside the exit as FIG. 2-11; the material limiting locator is a flat cone that enables a chip disk with a centered hole coming from the material feed gate fall on it and restrict their horizontal movement, the guide plate can smoothly receive the chip-disk falling from on the Transportor 1 material limiting locator and lead them to exit port when the fetch mode is working, the Transportor 1 can move between and along the two shelves at the bottom, the Transportor 2 can move up, down, and column by column, row by row, and s-grid by s-grid, the two transporters work in coordination with the access management system in FIG. 1-3, forming two modes of pipelines: store and fetch, Extraman in FIG. 2-9. differs according to material form and warehouse location;

as FIG. 3, Access Management Control System includes an Access Management Computer System as label 1, wherein there are a s-grid Database as label 2, a module of acquisiting info of incoming material as label 3, a module of deciding layout of the s-grid database as label 4, a module of controlling of store/fetch operations as label 5, a module of coordinating with supply-side as label 12; outside it, the system through network as label 11 connects to and control of incoming chip-disks information reader as label 6, Combined Access Mechanism Management Module as label 9, a Marking machine as label 10; the whole system is under control of management method of Intelligent Storage Chain System, as following;

In FIG. 4, the management method of Intelligent Storage Chain System comprises the steps (1) create a database that corresponds to the above shelves with 50 s-grid, each s-grid data includes many fields info such as chip-disks category (MCAT), demand-side sorting, quantity, frequency, transport sorting etc; (2) acquisit incoming material and their transport sorting etc information from demand-side such as 3 MCATs, A,B,C, quantity of MCAT A is 20, B is 10, C is 5, frequency is 1 time per day, the inquiry sorting is on supply-side's asking, transport sorting is FILO; (3) re-layout s-grids of s-database as: col.1 to col.2 are assigned to A, col.3 is assigned to B, col.4 is assigned to C, suggesting sorting of demand-side is C,B,A, so as to best match the local storage with demand-side; (4) store/fetch management operation as follow:

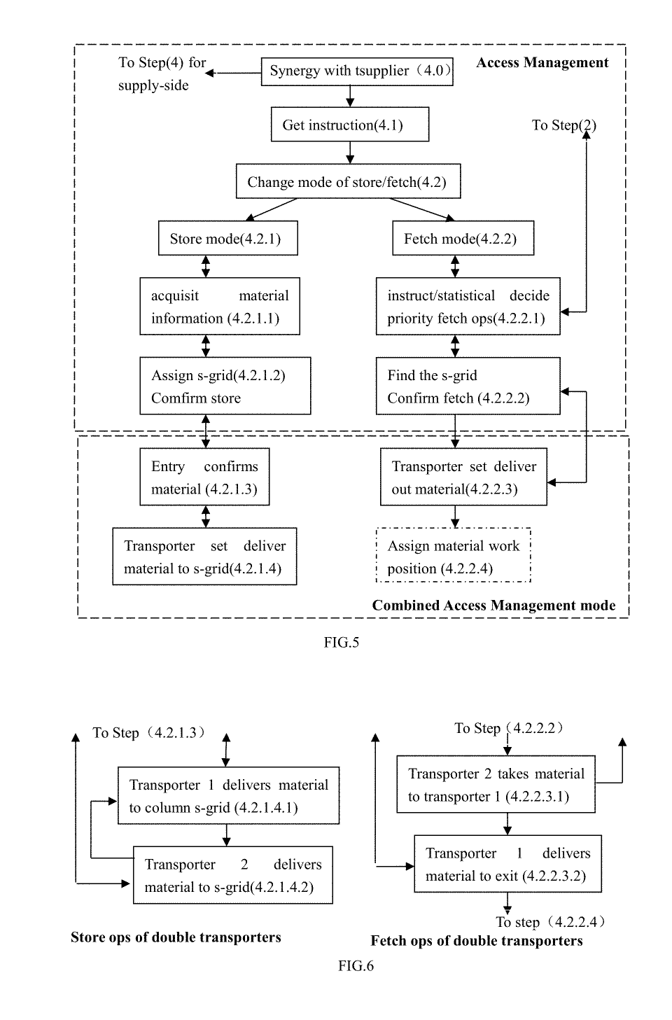

FIG. 5 shows a module of the access management, including step: (4.0) manage-synergy with the supply-side: send to the supply-side the local storage's MCAT category, local sorting, convey sorting of material, local sorting priority and its confirm, (4.1) as FIG. 3-1 through the keyboard of the Computer System get access instruction, (4.2) access mode change: (4.2.1) store-mode-operation, further includes (4.2.1.1) the reader as FIG. 3-6 read in information of incoming chip-disks, (4.2.1.2) assign s-grids to incoming chip-disks and print assignment code on the chip-disks using the Marking Machine as FIG. 3-10, in terms of chip-disks MCAT, s-areas and vacant s-grids, and send the assignment info to convey system, (4.2.1.3) confirm chip-disk arrival at the port IOPs, and transport system automatically open the chip-disk feed gate as FIG. 2-10 letting the chip-disk falling into the chip-disk limit locator as FIG. 2-2, and confirm the falling by the chip-disk feed sensor as FIG. 2-3 of the Combined Access Mechanism Management Module as FIG. 3-9, (4.2.1.4.1) Transportor 1 convey the material to its column: Transportor 1 receives “arrival” signal of the chip-disks from the sensor as FIG. 2-3, and then convey it to its assigned column, and decide following time of next chip-disk, column by column from the far-end to the near-end away from the IOP port, (4.2.1.4.2) Transportor 2 convey the material to its s-grid: Transportor 2 receives “arrival” signal of the chip-disk from the sensor as FIG. 2-3, and moves to the assigned col., then takes the chip-disk from Transportor 1 and convey it to its assigned s-grid, and inform the IOP port, s-database about “store-done”, then moves to the assigned col. of the next waiting chip-disk on Transportor 1 and take it to its assigned s-grid, and so on.

(4.2.2) fetch-mode-operation: further includes step (4.2.2.1) determine access optimization based on instruction of matching of local storages and demand-supply: arrange all the chip-disks on the list from small to large in column, then in term of the new arrangement, Transportor 2 takes out the chip-disks from their s-grids and put them column by column from the near-end to the far-end away from the IOP port onto Transportor 1 that will conveys the chip-disks out of the IOP port; (4.2.2.2) determine s-grids of material, (4.2.2.3.1) Transportor 2 moves to the s-grid position and takes the material out, bring it down to Transportor 1, and so on to move and take next fetch operation, (4.2.2.3.2) Transportor 1 conveys the material out of the port IOPs, send the “Done” info to s-database; start next fetch operation, (4.2.2.4) optional operations: print the s-grid code of demand-side on the fetched material.

As step (4.2.2.1) stated, determine access optimization based on either instruction, or demand-side sorting request, i.e., minimized fetch-operations of demand-side sorting; the said sorting may be chip-disk sorting at production lines, which has a fixed supply and demand relationship with their direct supply storage, for an example, a production line has 3 machines X,Y,Z, their distances from their entry/exit position are 0, 16, 32, represented as (X,0),(Y,16),(Z,32), which needs chip-disk sorting of C,A,B; the sorting of chip-disk vehicle used is FILO, the output sorting of the storage is chosen as demand-side priority of B,A,C, as a result, the chip-disk vehicle starts to download the chip-disk at the far-end of (Z,32) of the production line one by one backward, just obtains the demand-side needing sorting C,A,B; such priority makes the chain of the storage and production-line optimizated because the machines' position and spacing of a production line are much larger than the columns' spacing of a storage.

What is claimed as new and desired to be protected by Letters Patent is set forth in the following:

1. A method of storage chain system includes steps: create or adjust storage position layout or s-rack, and corresponding database, (2) get information about the incoming materials and their conveying mode, (3) decide the distribution of material storage area, and (4) access management

2. A method as defined in claim 1, wherein create or adjust storage position layout or s-rack, and corresponding database includes the steps of: relayout the material areas in order to minimize operations in the whole process of local storage access, convey, demand-side access.

3. A method as defined in claim 2, wherein adjust storage position layout or s-rack, and corresponding database includes the steps of: based on statistical data during a period, relayout the material areas in order to minimize operations in the whole process of local storage access, convey, demand-side access.

4. A method as defined in claim 2, wherein adjust storage position layout or s-rack, and corresponding database includes the steps of: relayout the material area includes 1) local storage access priority, 2) demand-side access priority, 3) matching priority of local storage access and demand-side.

5. A method as defined in claim 2, wherein adjust storage position layout or s-rack, and corresponding database includes the steps of: based on local storage layout, request supply-side to do their storage relayout for local storage as the above claim 2.

6. A method as defined in claim 1, further includes the steps of: request supply-side to do their storage access for local storage priority.

7. A method as defined in claim 1, further includes the steps of: based on local storage layout, demand-side material category, their convey tool, minimize access operations.

8. A method as defined in claim 7, the minimization further includes the steps of: local access priority: based on local storage layout, minimize access operations.

9. A method as defined in claim 7, the minimization further includes the steps of: local access priority: based on demand-side storage layout, minimize access operations.

10. A method as defined in claim 6, further includes the steps of: at least two transporters coordinates pipelines mode to make access operations.

11. An apparatus of storage chain system includes at least two transporters which form a pipeline set to do access operations.

12. As an apparatus as defined in claim 11, the features further includes one convey belt is installed directly under one transporter that can move in two dimensions at the same time.

13. As an apparatus as defined in claim 12, the features further includes on the convey belt there are material limit locators to limit the movement of the material in some extend.

14. As an apparatus as defined in claim 12, the features further includes there is a material feed sensor at the entry/exit port to coordinate transporters operations.

15. As an apparatus as defined in claim 12, the features further includes there is a material feed gate at the entry/exit port to guarantee material to be sent onto the material limit locator.
